(19) United States
(12) Patent Application Publication
(10) Pub. No.: US 2003/0131697 A1
(43) Pub. Date: Jul. 17, 2003

(54) Machining cutter

(76) Inventor: Donn E. Albert, Florissant, MO (US)

Correspondence Address: Henry W. Cummings, 3313 W. Adams St., St. Charles, MO, 63301, US

(21) Appl. No.: 10/047,390

(22) Filed: Jan. 16, 2002

(51) Int. Cl. B23B 3/00; B23B 25/00

(52) U.S. Cl. 82/117; 82/119

(57) ABSTRACT

In accordance with the present invention a cast or machined housing contains a drive system for turning a rotating cutter. An external source of rotation is attached to the housing. This external source can be a commercially available tool, such as a Craftsman angle grinder, or any rotating source of power provided by electric, hydraulic, or pneumatic means.

### FIELD OF THE INVENTION

This invention relates to rotating machining cutters which will reduce machining time with little or no loss in surface finish, and which can be adapted to be used with new or existing machining drive systems.

### BACKGROUND OF THE INVENTION

U.S. Pat. Nos. 5,664,917 and 548,822 disclose a drive system and a cutter head for machining a hollow work piece and the cutter head is located within the hollow work piece.

U.S. Pat. No. 4,715,752 discloses a cutter head 17 for machining a work piece W in which replacement of the cutter head is simplified.

### SUMMARY OF THE INVENTION

A. Objects of the Invention

One object of the present invention is to provide a cutter assembly which will reduce machining time with little or no loss in surface finish.

Another object of the invention is to provide a cutter assembly which is simple in construction.

Another object of the invention is to provide a cutter assembly in which the cutter is located on at least one axis of an existing drive system.

Other objects will be apparent from the following Descriptions and Drawings.

B. Summary

In accordance with the present invention a cast or machined housing contains a drive system for turning a rotating cutter. An external source of rotation is attached to the housing. This external source can be a commercially available tool, such as a Craftsman angle grinder, or any rotating source of power provided by electric, hydraulic, or pneumatic means.

### THE DRAWINGS

FIG. 1 is an exploded perspective view of the preferred embodiment of the invention.

FIG. 2 is a top view of the preferred embodiment of the invention, showing internal parts, with some parts omitted for clarity.

FIG. 3 is a side view of the preferred embodiment of the invention, showing internal parts, with some parts omitted for clarity.

FIG. 4 is a side view of the preferred embodiment of the invention, showing how it may be attached to a commercially available tool.

FIG. 5 is a top view of another embodiment of the invention, showing internal parts.

FIG. 6 is a top view of another embodiment of the invention, showing internal parts.

FIG. 7 is a sectional view along 7-7 of the embodiment shown in FIG. 6, showing internal parts.

FIG. 8 is a top view of another embodiment of the invention, showing internal parts.

FIG. 9 shows how the invention might be substituted for a hand tool in a wood lathe.

FIG. 10 shows a modified lathe with an X/Y axis drive system.

### DESCRIPTION OF PREFERRED EMBODIMENTS

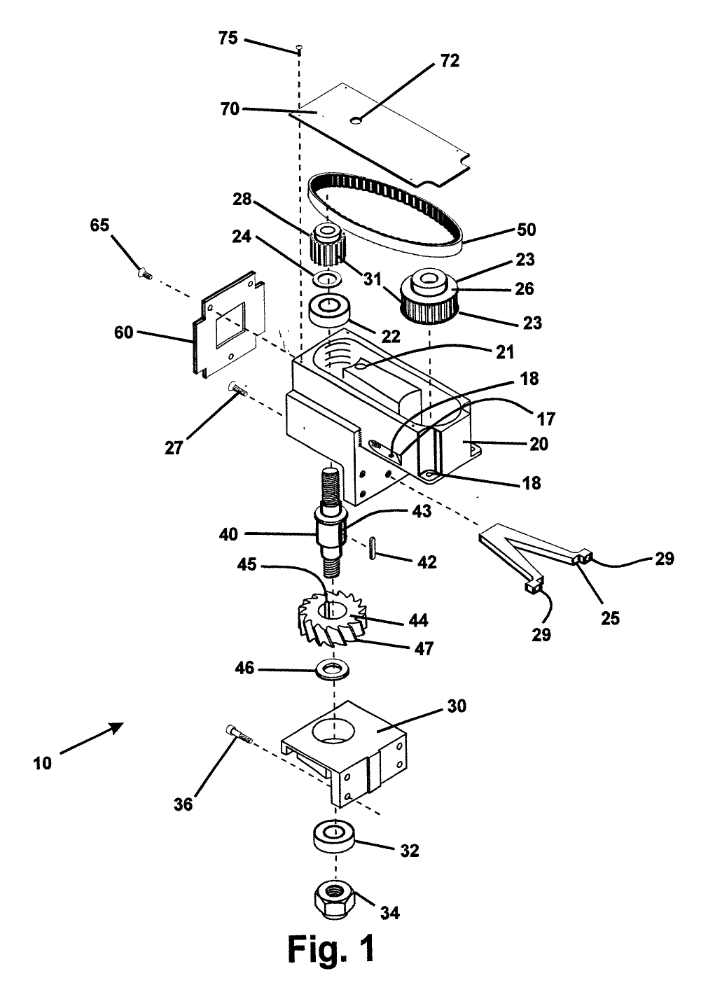

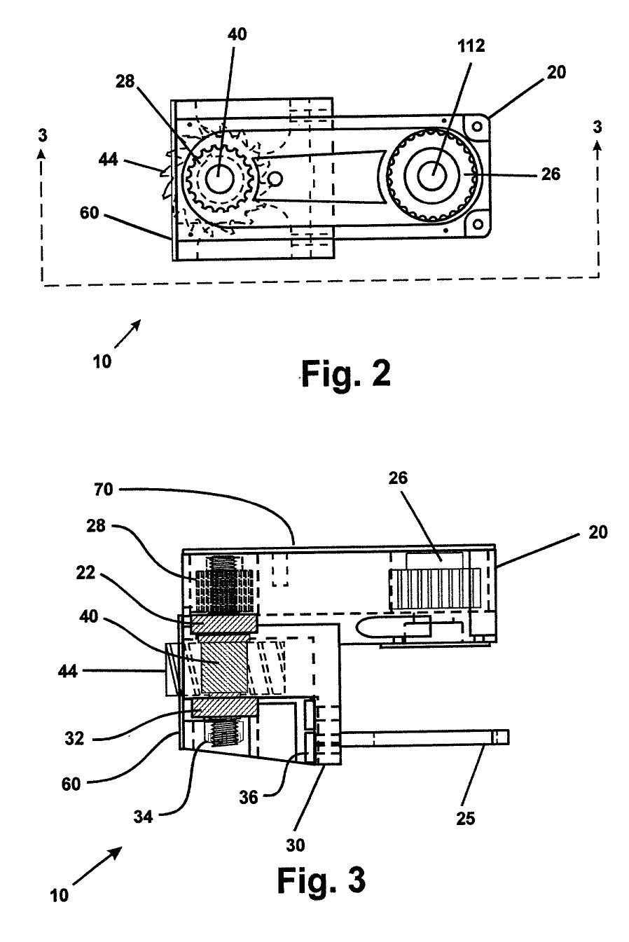

In accordance with the present invention, FIG. 1 shows the preferred embodiment of the invention generally at 10. The parts are attached to or located inside of main housing 20, which is made of metal, heavy durable plastic, or other suitable material.

Main housing 20 includes a threaded hole 21, which will accept a handle or other part of the commercially available angle grinder. Main housing 20 is mounted to the commercially available angle grinder by means of mounting holes 18, two of which are accessible via recesses 17.

Drive gear 26 is made of metal, heavy durable plastic, or other suitable material and is mounted inside main housing 20. Drive gear 26 will accept a right-hand threaded drive shaft from a commercially available hand tool, such as a Craftsman angle grinder. Driven gear 28 is made of metal, heavy durable plastic, or other suitable material. Drive gear 26 and driven gear 28 have teeth 31 around their circumference which engage the teeth on toothed drive belt 50. In addition, drive gear 26 has flanges 23 on its upper and lower radius to keep toothed drive belt 50 engaged.

Shaft 40 is made of metal or other suitable material. Shaft 40 is mounted to driven gear 28 via commercially available upper bearing 22 and commercially available upper bushing 24. Shaft 40 and driven gear 28 have matching left-hand threads, which tend to tighten driven gear 28 onto shaft 40 during operation of shaft 40.

Cover 70 is made of metal, heavy durable plastic, or other suitable material, and is attached to the top of main housing 20 by means of cover screws 75. Cover 70 includes a hole 72 which allows access to the threaded hole 21 in main housing 20.

Cutter wheel 44 is a commercially available unit such as made by KBC in Poland. It is resharpened to a 1.50 radius and with a rake angle of 2° to 4°. Cutter wheel 44 contains sharpened teeth 47 and keyway 45. Cutter wheel 44 is mounted on shaft 40, and is locked rotationally to shaft 40 by means of commercially available key 42 which fits into key receptacle 43 and keyway 45.

Commercially available lower bushing 46 provides spacing between shaft 40 and commercially available lower bearing 32. Lower bearing 32 fits into a recess in lower housing 30. Lower housing 30 is made of metal, durable plastic, or other suitable material. Lock nut 34 is commercially available, and retains lower bearing 32, lower bushing 46, and cutter wheel 44. Lower housing 30 is further secured to main housing 20 by means of cap screws 36.

Brace 25 is an optional part made of metal, durable plastic, or other suitable material and provides rigidity of the assembly with respect to the hand-held angle grinder. Brace 25 is mounted to main housing 20 by means of brace screw 27. Brace 25 has mounting holes 29 which mate to the screws on the face of the commercially available angle grinder.

Spacer 60 is made of nylon, teflon, or other smooth material. It is mounted to main housing 20 by means of spacer screws 65. Spacer 60 provides means to alter the cutting depth of cutter wheel 44. With spacer 60 in place, the cut is shallow; with spacer 60 removed, the cut is deeper, and useful in testing and in operation.

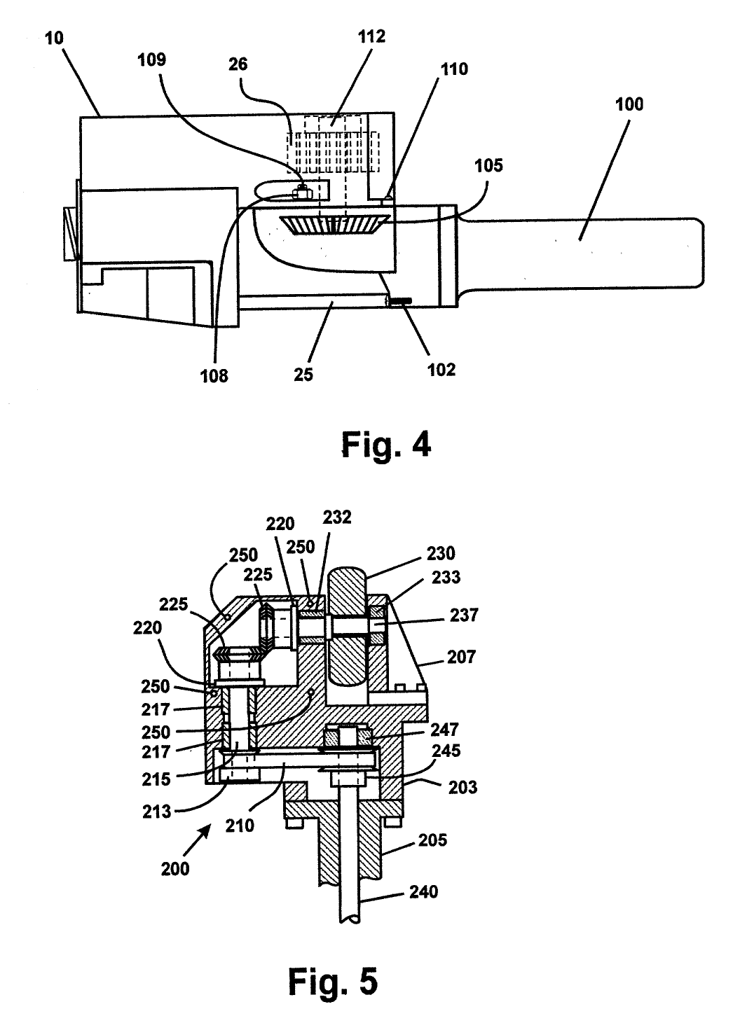

FIG. 4 shows preferred embodiment 10 mounted on commercially available die grinder 100. Existing parts of the angle grinder include bevel gear 105, shaft 112, and screws 110. Bevel gear 105 provides the means to transfer the rotation of the tool's motor 90 degrees. Shaft 112 is mounted to and driven by bevel gear 105, and mates with drive gear 26 as described above. The assembly is secured to the angle grinder by means of optional brace 25, brace screws 102, hex nuts 108, studs 109, and screws 110.

FIG. 5 shows a second embodiment of the invention, generally at 200. The parts can be made from any combination of metal, plastic, or other suitable materials. The assembly includes main housing 203, drive shaft housing 205, and driven shaft support housing 207. A cover (not shown) provides protection for moving parts, and is attached with fasteners extending through holes 250.

Rotational force is applied to drive shaft 240 from an external high RPM source not shown. The can be electrical, hydraulic, or pneumatic. Drive shaft 240 rotates through drive shaft bearing 247, and turns drive shaft gear 245. This rotational movement is transferred to secondary shaft gear 213 via toothed drive belt 210. Drive shaft gear 245 and secondary shaft gear 213 have teeth to allow toothed drive belt 210 to transfer that motion without slippage. Secondary shaft gear 213 turns secondary shaft 215 via secondary shaft bearings 217.

Secondary shaft 215 turns a system of bevel gears 225, which change the plane of rotation 90 degrees. Driven shaft 237 is attached to one of the bevel gears 225, and is rotated via upper driven shaft bearing 232 and lower drive shaft bearing 233. Both secondary shaft 215 and driven shaft 237 employ thrust bushings 220. Cutter wheel 230 is attached to driven shaft 237 by a key (not shown) or other known means.

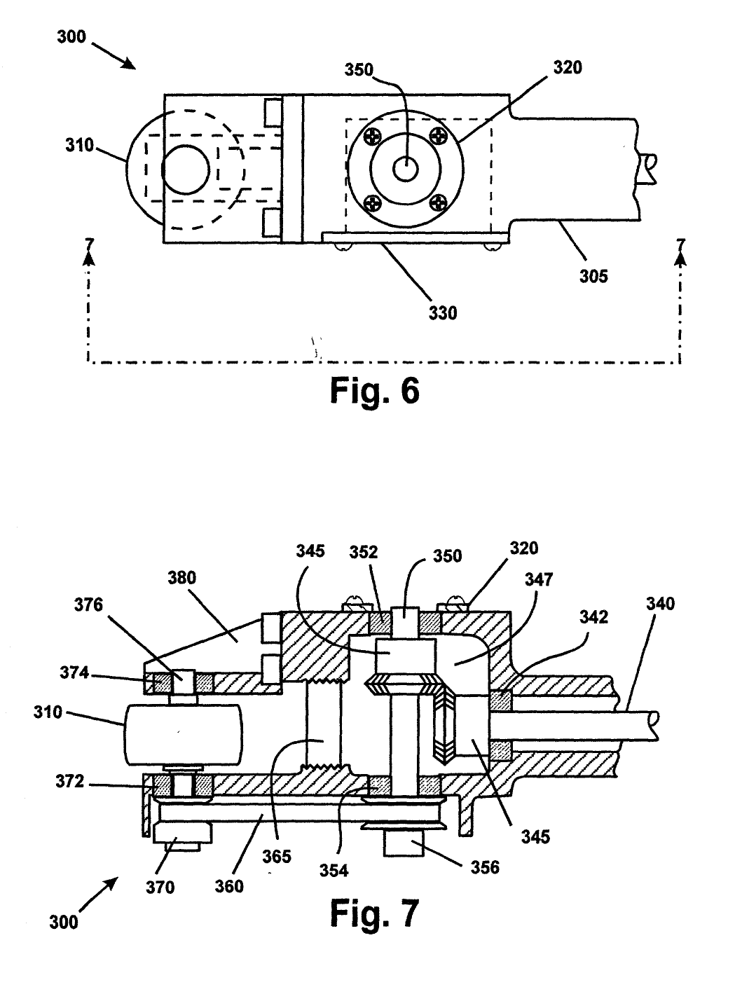

FIGS. 6 and 7 show two views of a third embodiment of the present invention, generally at 300. All parts can be made from any combination of metal, plastic, or other suitable materials. Main mounting components comprise housing 305, driven shaft support housing 380, gearbox cover 330, and shaft seal cover 320.

Rotational force is applied to drive shaft 240 from an external high RPM source, not shown which may be electrical, hydraulic, or pneumatic. Drive shaft 340 rotates through drive shaft bearing 342, and turns a system of bevel gears 345, which change the plane of rotation 90 degrees. This rotational movement is transferred to secondary shaft 350, which is mounted by means of upper secondary shaft bearing 354 and lower secondary shaft bearing 352. The bevel gears 345 rotate in an oil-filled chamber 347. A threaded plug 365 may be removed to add or change the oil in chamber 347.

Secondary shaft 350 turns secondary shaft gear 354, which transfers its rotation to driven shaft gear 370 via toothed drive belt 360. Both secondary shaft gear 354 and driven shaft gear 370 have teeth to allow toothed drive belt 360 to transfer that motion without slippage. Driven shaft 376 is turned by driven shaft gear 370, and rotates by means of upper driven shaft bearing 372 and lower driven shaft bearing 374. Cutter wheel 310 is attached to driven shaft 376 by a key, not shown or other common means.

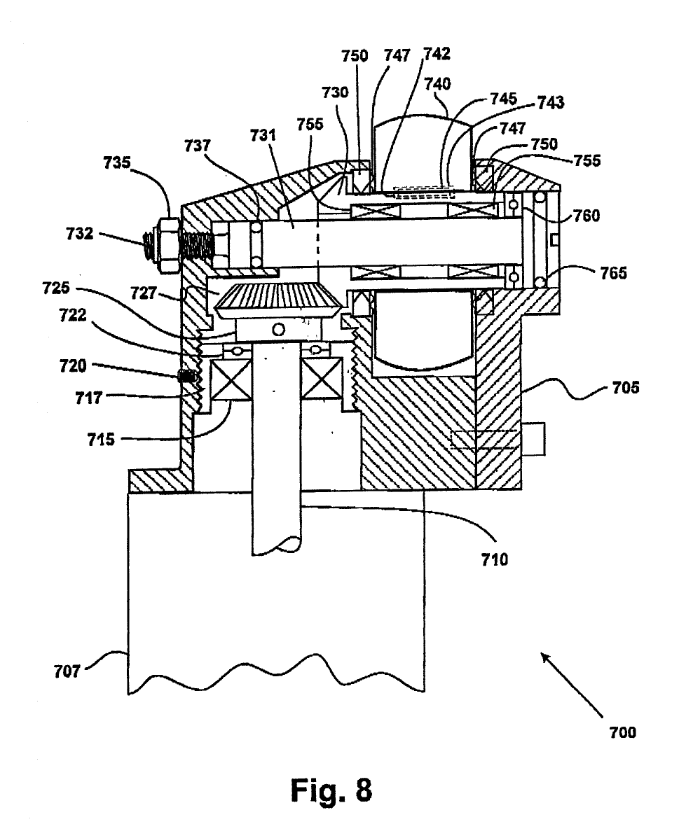

FIG. 8 shows a fourth embodiment of the present invention, generally at 700. The main mounting housing 705 is attached to a source of outside power 707 from an external high RPM source, not shown, which may be electrical, hydraulic, or pneumatic. Power shaft 710 is driven by the source of outside power 707, and is held in place by sealed bearing 715 and threaded seal 717. Set screw 720 maintains the position of threaded seal 717 relative to housing 705. Thrust bearing 722 limits lengthwise travel of powered shaft 710. Bevel gear 725 is mounted to and turned by powered shaft 710. Bevel gear 725 meshes with bevel gear 730, effectively turning the plane of rotation 90°.

Bevel gear 730 turns around fixed shaft 731, which is secured to housing 705 by means of threaded end 732, locknut 735, and thrust bearing 760. Oil is prevented from leaking from hollow chamber 727 by o-rings 737 and 765, seals 750, and sealed bearing 715. Needle bearings 755 allow free rotational motion of bevel gear 730 around fixed shaft 731. Keyway 742 is cut into the shaft portion of bevel gear 730, and accepts key 745. Key 745 is also accepted by keyway 743, recessed into cutter wheel 740. Key 745 thus fixes the position of cutter wheel 740 relative to bevel gear 730.

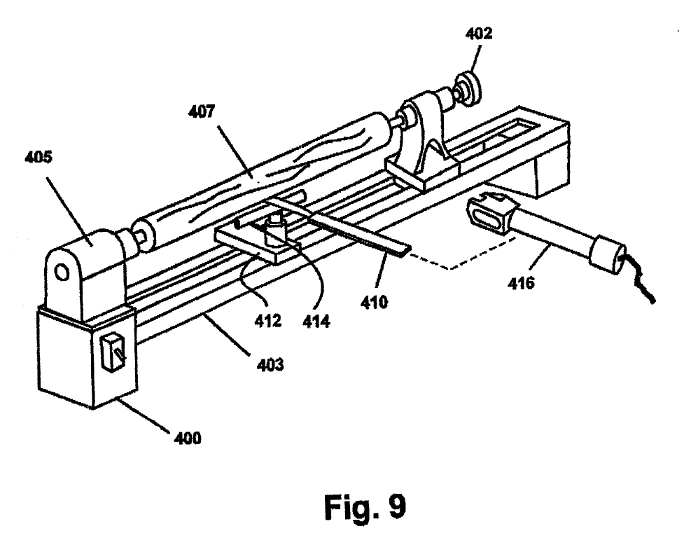

FIG. 9 shows a common wood lathe 400. A wood workpiece is mounted on the lathe by means of head stock 405 and tail stock 402. A hand lathe tool 410 is held on tool rest 414, which is mounted to tool rest support 412. Rotating cutter 416, in its preferred embodiment replaces hand lathe tool 410, providing faster and smoother cutting.

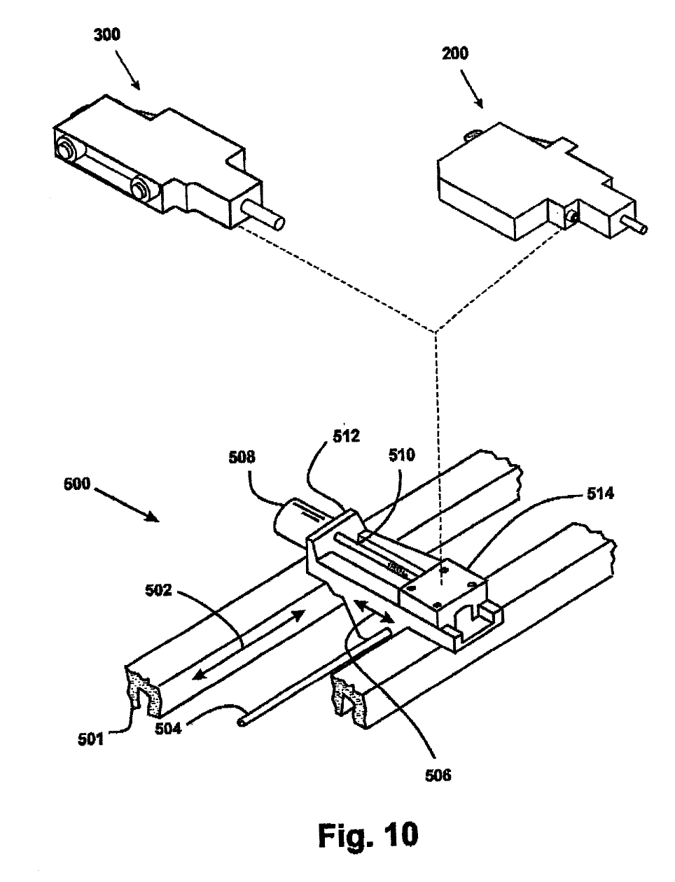

FIG. 10 illustrates a lathe 500 having drives to move a tool support in the X and Y axes. Cross slide 512 moves in the X axis 502 back and forth across lathe bed 501 by means of X axis drive shaft 504. Rotating cutter unit mounting block 514 moves in the Y axis 506 back and forth across cross slide 512 by means of Y axis drive motor 508.

What is claimed is:

1. A rotating cutter assembly comprising:
A housing,
means for attaching said housing to an external drive source; and
means for transferring rotational movement from said external drive having an output shaft to a cutting wheel.

2. An assembly according to claim 1 wherein said means for attaching said housing comprise a drive gear having means for engaging said output shaft of said power tool.

3. An assembly according to claim 2 wherein said means for transferring rotational movement results in said cutting wheel turning in the same plane as said drive source.

4. An assembly according to claim 2 wherein said means for transferring rotational movement results in said cutting wheel turning in a different plane of rotation from said drive source.

5. An assembly according to claim 3 wherein said power source is hand-held.

6. An assembly according to claim 3 wherein said power source is connected to a new or existing lathe.

7. A housing according to claim 1 said power source is selected from electrical, hydraulic, and pneumatic power sources.

8. An assembly according to claim 7 wherein said power source is connected to a new or existing lathe having means for moving said power source in both the X and Y axes.

9. An assembly according to claim 4 wherein said assembly includes a main housing and means for attaching a commercially available grinder to said housing.

10. An assembly according to claim 9 wherein said main housing includes at least one threaded opening which receive fasteners to attach a portion of a commercially grinder.

11. An assembly according to claim 10 wherein said main housing includes a drive gear made of material selected from metal, heavy durable plastic, or other suitable material mounted within said main housing.

12. An assembly according to claim 11 including wherein said drive gear has means for engaging a drive shaft from said commercially grinder.

13. An assembly according to claim 12 including wherein said drive gear drives a driven gear made of a material selected from metal, heavy durable plastic, or other suitable material.

14. An assembly according to claim 13 including wherein said drive gear drives said driven gear by means of toothed drive belt.

15. An assembly according to claim 14 wherein said driven gear drives a cutter shaft made of a material selected from metal, heavy durable plastic, or other suitable material.

16. An assembly according to claim 15 wherein said cutter shaft Shaft and said driven gear have matching left-hand threads, which tend to tighten said driven gear onto said cutter shaft during operation of said cutter shaft.

17. An assembly according to claim 15 wherein said cutter shaft drives a cutter wheel which contains sharpened teeth for machining.

18. An assembly according to claim 17 wherein said cutter has a rake angle of of about 2° to 5°.

19. An assembly according to claim 15 including means to alter the cutting depth of said cutter wheel.

20. An assembly according to claim 19 wherein said means to alter the cutting depth of said cutter wheel comprises a spacer made of a material selected from nylon, teflon, or other smooth material.

21. An assembly according to claim 19 wherein with spacer in place, the cut is more shallow than when said spacer is not in place.

22. An assembly according to claim 15 wherein said angle grinder includes a bevel gear, and a bevel gear shaft and said bevel gear provides means to transfer the rotation of said grinder 90 degrees.

23. An assembly according to claim 22 wherein said assembly is secured to said angle grinder by means of a brace and mechanical fasteners.

24. An assembly for driving a rotating cutter comprising:
a housing containing a drive shaft extending from a power source having a drive shaft gear;
first means for transferring rotational torque to a secondary drive shaft laterally spaced from said drive shaft but extending generally parallel to said drive shaft;
second means for transferring rotational torque 90 degrees to a third drive shaft extending generally perpendicular to said secondary drive shaft which in turn drives a rotating cutter.

25. An assembly according to claim 24 wherein said rotational torque is transferred to said secondary drive shaft with a toothed drive belt assembly.

26. An assembly according to claim 24 wherein said rotational torque is transferred to said third shaft with a system of bevel gears.

27. An assembly according to claim 24 wherein said cutter is spaced from said power source.

28. An assembly according to claim 25 wherein said cutter is located in the same plane as said power source.

29. An assembly according to claim 24 wherein said power source is selected from electrical, hydraulic, or pneumatic power.

30. An assembly according to claim 24 wherein said rotational torque is transferred to said third drive shaft with a toothed drive belt assembly.

31. An assembly according to claim 24 wherein said rotational torque is transferred to said secondary shaft with a system of bevel gears.

32. An assembly according to claim 30 wherein said rotational torque is transferred to said secondary shaft with a system of bevel gears.

33. An assembly for driving a rotating cutter comprising:
a housing containing a drive shaft extending from a power source having a drive shaft gear;
first means for transferring rotational torque to a secondary drive shaft laterally spaced from said drive shaft but extending generally perpendicular to said drive shaft; and
said secondary drive shaft which in turn driving a rotating cutter.

34. An assembly according to claim 33 wherein said rotational torque is transferred to said secondary shaft with a system of bevel gears.
